(19) United States
(12) Patent Application Publication
(10) Pub. No.: US 2007/0211702 A1
(43) Pub. Date: Sep. 13, 2007

(54) Methods and apparatus to perform parallel ringing across communication networks

(76) Inventors: Anil Kumar Doradla, Austin, TX (US); Steven William Frew, Plugerville, TX (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/370,434

(22) Filed: Mar. 8, 2006

(51) Int. Cl. H04L 12/66

(52) U.S. Cl. 370/356

(57) ABSTRACT

Methods and apparatus to perform parallel ringing across communication networks are disclosed. A disclosed example voice over Internet protocol (VoIP) apparatus comprises a database identifying a parallel ring destination associated with a VoIP destination; and a VoIP feature server to respond to an incoming call to the VoIP destination by initiating a first call to the VoIP destination at a first time and initiating a second call to the parallel ring destination at a second time, wherein the first and the second times are based on a difference between a first call setup time duration associated with the VoIP destination and a second call setup time duration associated with the parallel ring destination.

### FIELD OF THE DISCLOSURE

This disclosure relates generally to communication networks and, more particularly, to methods and apparatus to perform parallel ringing across communication networks.

### BACKGROUND

Parallel ringing is one of many advanced features offered by communication service providers such as, for example, providers of voice over Internet protocol (VoIP), cellular and/or public switched telephone network (PSTN) based communication services. When parallel ringing is enabled for a telephone number, a call placed to the telephone number causes additional configured telephone numbers to ring. In some example systems, parallel ring is offered as a user and/or consumer configurable service that can be configured by a user and/or consumer using, for example, a web portal. The user and/or consumer specifies and/or configures a telephone number with the additional telephone numbers to be rung when a call is placed to the configured telephone number.

As used herein, parallel ringing is meant to indicate that one phone call causes multiple devices of the same or different phone numbers to ring or otherwise give an alert and/or indication of a call. Currently, the ringing may not occur at the same time depending upon network characteristics, etc. An example parallel ring service is commonly referred to in the industry as simultaneous ring. However, the term parallel ringing will be used herein as the additional telephone numbers that are rung may not actually ring simultaneously, even if a user perceives them to do so.

### BRIEF DESCRIPTION OF THE DRAWINGS

FIG. 1 is a schematic illustration of an example voice over Internet protocol (VoIP) communication system to perform parallel ringing across communication networks.

FIG. 2 is a schematic illustration of an example manner of implementing the example feature server of FIG. 1.

FIGS. 3A and 3B illustrate example data structures to store parallel ring configuration information.

FIG. 4 illustrates an example parallel ring operation for the example VoIP communication system of FIG. 1

FIG. 5 is a flowchart representative of example machine accessible instructions which may be executed to implement the example feature server of FIG. 1.

### DETAILED DESCRIPTION

Methods and apparatus to perform parallel ringing across communication networks are disclosed. A disclosed example voice over Internet protocol (VoIP) apparatus includes a database identifying a parallel ring destination associated with a VoIP destination; and a VoIP feature server to respond to an incoming call to the VoIP destination by initiating a first call to the VoIP destination at a first time and initiating a second call to the parallel ring destination at a second time, wherein the first and the second times are based on a difference between a first call setup time duration associated with the VoIP destination and a second call setup time duration associated with the parallel ring destination. Another disclosed example apparatus includes a memory to store delay information associated with a parallel ring tree; and a communication device to initiate calls to destinations identified in the parallel ring tree at time instants selected based at least in part on the stored delay information.

A disclosed example method includes receiving an incoming call placed to a voice over Internet protocol (VoIP) destination, initiating a first communication path to the VoIP destination at a first time, and initiating a second communication path to a second destination at a second time, wherein an elapsed time difference between initiating the first time and the second time depends upon delays associated with the VoIP destination and the second destination.

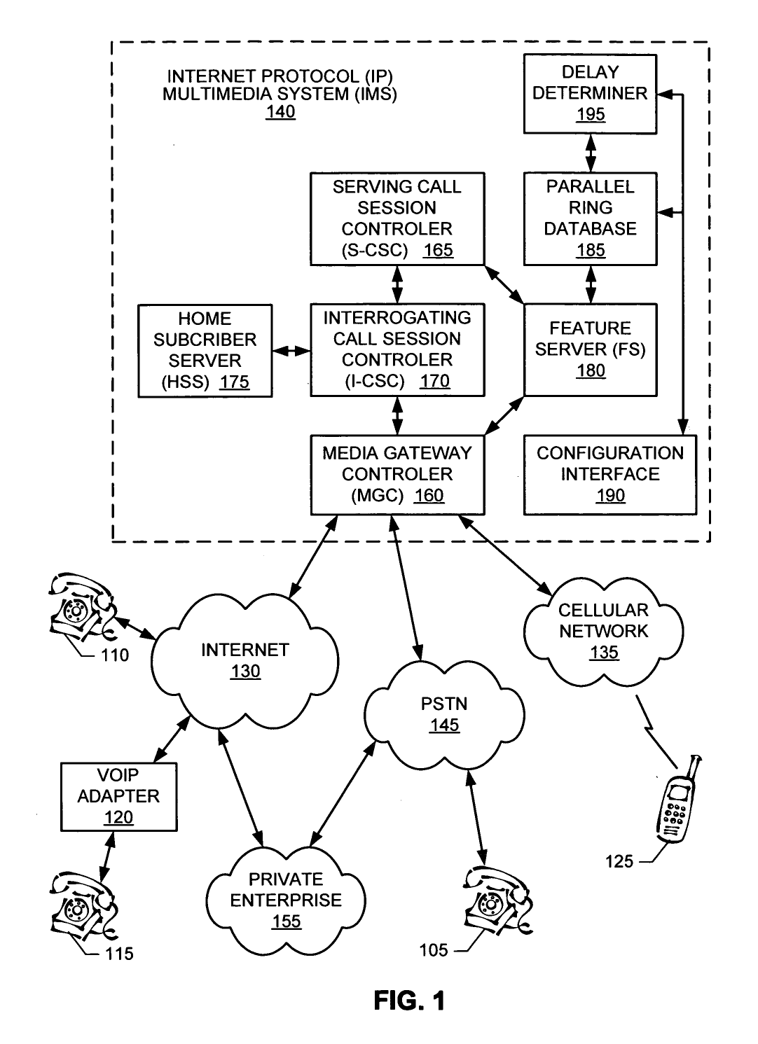

FIG. 1 is a schematic illustration of an example voice over Internet protocol (VoIP) communication system. In the illustrated example system of FIG. 1, communication sessions (e.g., telephone calls) may be placed from, to and/or between any variety of communication devices such as, for example, a wired or cordless PSTN-based telephone 105, a VoIP telephone 110 and/or VoIP based communication device 110, a telephone and/or communication device 115 communicatively coupled to for example, a VoIP adapter 120, and/or a wireless (i.e., cellular) communication and/or telephony device 125. The example communication devices 105, 110, 115, 120 and/or 125 of FIG. 1 may be used to implement and/or provide any variety of communication services such as, for instance, voice and/or data telephony services, messaging services, voicemail services, Internet communication services, instant messaging, chat services, etc.

As illustrated in FIG. 1, the example communication devices 105, 110, 115, 120 and/or 125 may be communicatively coupled via any variety of communication devices, communication systems and/or communication networks. For example, the example VoIP telephone 110 may communicate with the example telephone 115 via an Internet-based network (e.g., the Internet 130) and the VoIP adapter 120. The example cellular telephone 125 may communicate with the example VoIP telephone 110 via any variety of cellular communication network(s) 135, any variety of VoIP communication network such as, for example, an Internet protocol (IP) multimedia system (IMS) 140 and the Internet 130. The example telephone 105 may communicate with the example telephone 115 via any variety of PSTN 145, the example IMS 140, the Internet 130 and the VoIP adapter 120; etc. Additionally, as illustrated in FIG. 1, any variety of communication and/or telephony device(s) associated with a private network and/or private enterprise 155 may also be connected to the example communication devices 105, 110, 115, 120 and/or 125 of FIG. 1 via any variety communication devices, communication systems and/or communication networks.

While the following disclosure refers to the example VoIP system and/or the example communication and/or telephony devices 105, 110, 115, 120 and/or 125 of FIG. 1, the example system of FIG. 1 may be used to provide services to, from and/or between any alternative and/or additional variety and/or number of communication devices (e.g., telephone devices, personal digital assistants (PDA), laptops, etc.). Additionally, although for purposes of explanation, the following disclosure refers to example systems, devices and/or networks 130, 135, 140 and/or 145 illustrated in FIG. 1, any additional and/or alternative variety and/or number of communication systems, devices and/or network may be used to implement a communication system and/or provide communication services in accordance with the teachings disclosed herein.

Further, while for purposes of illustration, the follow disclosure references performing parallel ring in VoIP communication systems and/or networks, persons of ordinary skill in the art will readily appreciate that the apparatus and methods disclosed herein may additionally or alternatively be applied to any type of communication system and/or network such as, for example, the PSTN 145, the cellular network 135, the private enterprise 155, etc. It will be further appreciated that, while for purposes of illustration, the following disclosure refers to telephone numbers and telephone calls, the following methods and apparatus may additionally or alternatively be used to establish other types of communication sessions such as, for example, messaging sessions, email sessions, etc.

Moreover, the term “ringing” is used herein to indicate that a telephone call is initiated to a called telephone number. The initiated telephone call may or may not physically result in a telephone being rung, but the intention of the call is to cause a telephone to alert a called party of the call by ringing and/or some other notification mechanism (e.g., vibration, lights, message, etc.).

In the example VoIP communication system of FIG. 1, the VoIP telephone 110, the VoIP adapter 120 and/or the IMS 140 utilize, among other things, VoIP protocols including the session initiation protocol (SIP) as specified in Internet Engineering Task Force (IETF) request for comment (RFC) documents 3161, 3262, 3263, 3264, 3265, 3266, etc. However, the example devices, systems and/or networks illustrated in FIG. 1 may implement and/or utilize any variety of additional and/or alternative communication protocols, VoIP communication protocols, methods and/or techniques to provide communication and/or telephone services such as, for example, the International Telecommunications Union (ITU-T) H.323 standard.

To process and/or handle VoIP communication services between the example communication devices 105, 110, 115, 120 and/or 125, the example IMS 140 of FIG. 1 includes any variety of media gateway controller(s) (MGC) 160. Using any of a variety of techniques, methods and/or in accordance with any variety of standards such as, for example, IETF RFC 3015 or the ITU-T H.248 standard, the example MGC 160 of FIG. 1 performs signaling and/or session management needed for incoming and/or outgoing VoIP communication sessions. For example, the MGC 160 of FIG. 1 performs data conversion between the circuit-based format used by the PSTN 145 and a packet-based format used by the IMS 140, the Internet 130, the VoIP phone 110 and/or the VoIP adapter 120.

In the illustrated example of FIG. 1, each subscriber and/or VoIP communication device (e.g., the VoIP telephone 110, the VoIP adapter 120, etc.) is registered to, associated with and/or assigned to one of any variety of serving call session controller(s) (S-CSC) (e.g., the S-CSC 165) responsible for handling incoming and/or outgoing calls associated with the subscriber and/or VoIP communication device. That is, the example S-CSC 165 of FIG. 1 performs sessions control for its associated subscribers and/or VoIP devices. For instance, for a VoIP communication device initiating an outgoing telephone call, a SIP INVITE message is routed by the IMS 140 to its associated S-CSC which, in turn, routes and/or assists in establishing a communication path and/or communication session (e.g., a telephone call) with a called device (i.e., a called party). Likewise, a VoIP communication device receiving an incoming communication session receives a SIP INVITE message via its associated S-CSC. The example S-CSC 165 maintains session state for each current subscriber and enables communication with application servers and/or content servers to provide any variety of features such as, for example, parallel ringing.

To locate the S-CSC associated with a subscriber, the example IMS 140 of FIG. 1 includes any variety of interrogating call session controller(s) (I-CSC) (e.g., the I-CSC 170). The example I-CSC 170 of FIG. 1 serves as the contact point within the example IMS 140 for all connections destined for a subscriber of the IMS 140 and/or for a subscriber currently located within the serving area of the IMS 140 (i.e., a roaming subscriber). For an incoming communication session (e.g., a telephone call), the example I-CSC 170 identifies which S-CSC (e.g., the S-CSC 165) will process SIP requests for the subscriber associated with the incoming session.

To centrally manage subscriber information and/or to enable subscribers and/or servers to locate destinations, the example IMS 140 of FIG. 1 includes any variety of home subscriber server(s) (e.g., the HSS 175). The example HSS 175 of FIG. 1 maintains a profile and/or preferences for each subscriber of the IMS 140. The example I-CSC 170 uses information contained in the HSS 175 to determine and/or locate the S-CSC associated with a subscriber.

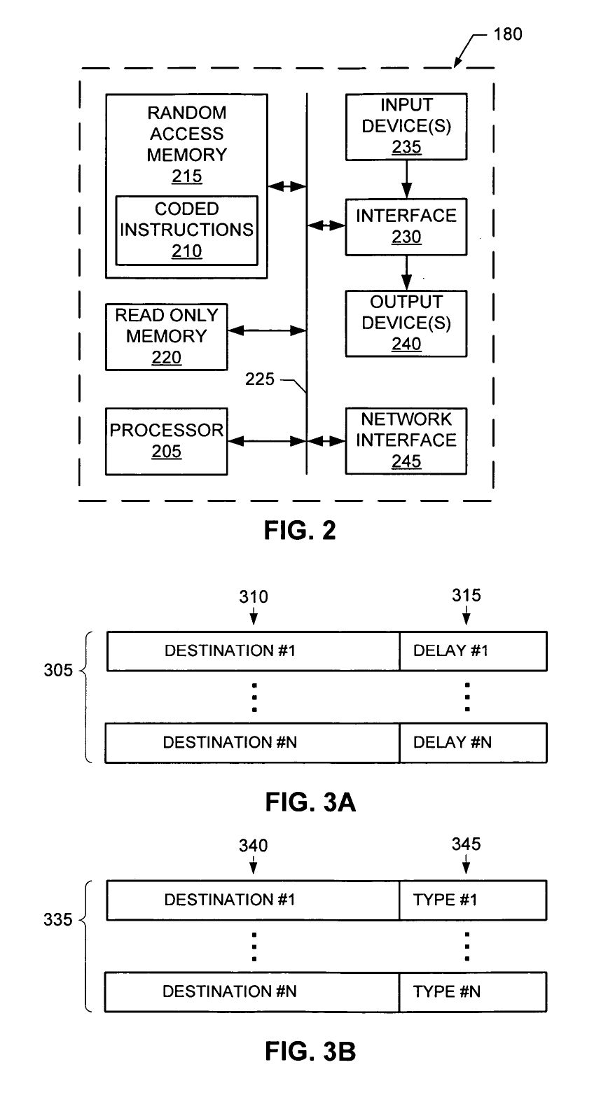

To provide and/or enable any variety of communication services such as, for example, parallel ringing, the example IMS 140 of FIG. 1 includes any variety of feature server(s) (FS) (e.g., the FS 180). Upon receiving notification of an incoming call for a subscriber (i.e., a called party), the example FS 180 of FIG. 1, using any variety of techniques and/or methods, determines if the called party has parallel ringing configured and/or enabled. If the called party has parallel ringing configured and/or enabled, the example FS 180 initiates a communication session to each of the configured parallel ring destinations. An example manner of implementing the example FS 180 is discussed below in connection with FIG. 2.

In the example system of FIG. 1, a subscriber's configured parallel ring destinations may be associated with any type(s) and/or combination(s) of communication network(s) such as, for example, the example IMS 140, the PSTN 145, the cellular network 135 and/or the private enterprise 155. Since two communication networks and/or communication systems may have different call setup times and there may be communication delays between the two networks, there may be a user perceivable time difference between the time instants when two parallel ring destinations start ringing if the communication network initiating the parallel ringing initiates the calls to both destinations at substantially the same time. Consider an example incoming call placed to a VoIP destination (e.g., a VoIP telephone number) for which the subscriber associated with the VoIP destination has enabled and/or configured parallel ringing to a cellular phone in addition to the VoIP destination. Because an example call setup time to the cellular phone is longer than that for the VoIP phone associated with the VoIP telephone number, the VoIP phone may start ringing a user perceptible time before the cellular phone rings if the call setups are initiated at the same time. Thus, the example FS 180 of FIG. 1 delays initiating the call setup to the VoIP destination so that both the cellular phone and the VoIP destination ring at substantially the same time or at least close enough together in time to be perceived by the subscriber as ringing simultaneously.

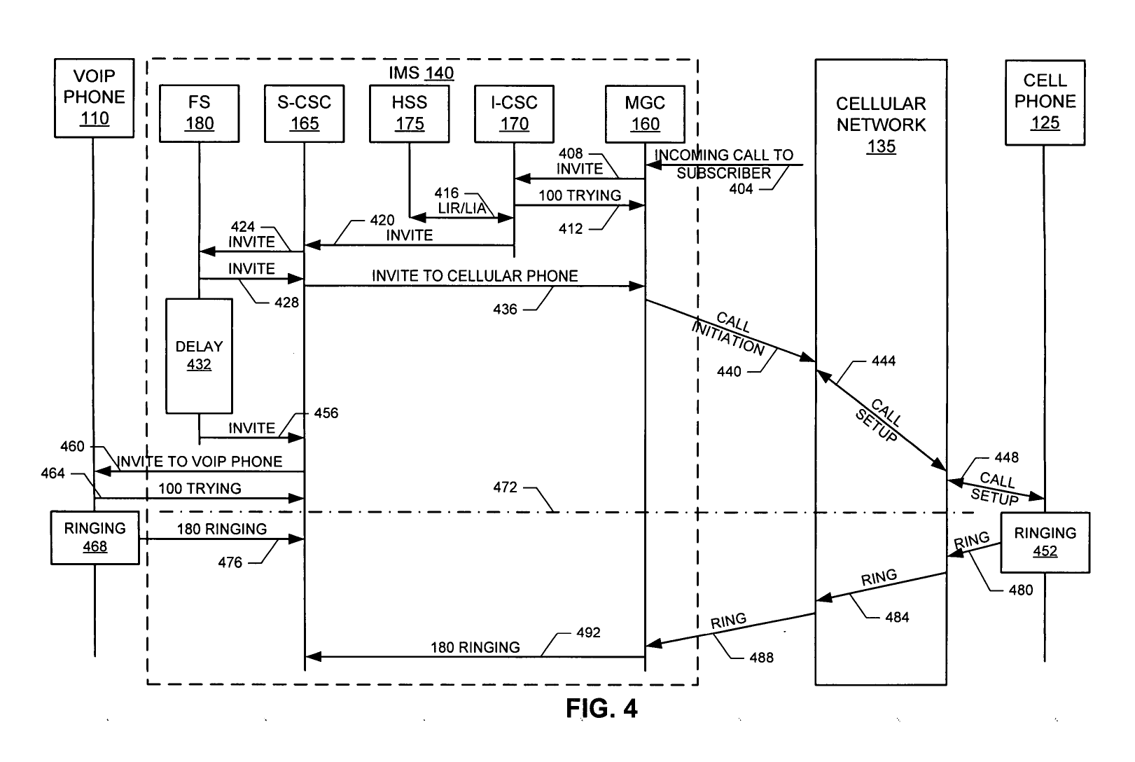

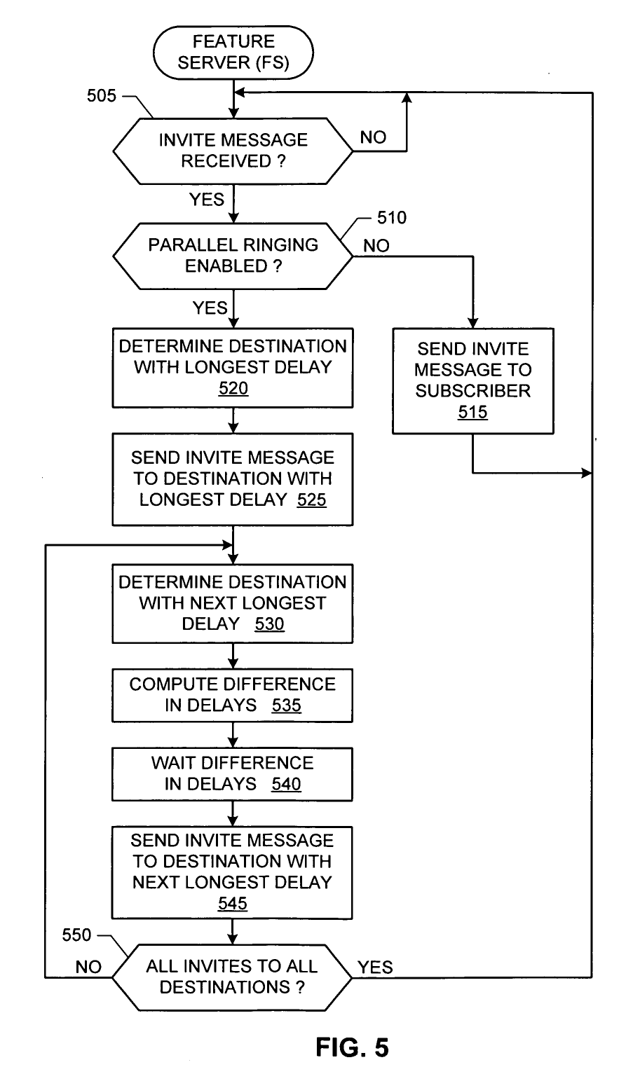

To store parallel ring configuration information, the example IMS 140 of FIG. 1 includes a parallel ring database 185. As discussed below in connection with FIG. 3, the parallel ring database 185 includes a list of destinations (e.g., telephone numbers) to be alerted (e.g., rung) when an incoming call associated with a subscriber is received. The set of destinations listed in the parallel ring database 185 for a subscriber is generally unique to each subscriber, but need not be so. The example parallel ring database 185 also includes a call setup time duration (i.e., delay) associated with each configured parallel ring destination. The associated call setup time duration for a destination represents the time between when a FS (e.g., the FS 180) initiates a communication path and/or session (e.g., a telephone call) to the destination and the time when a device (e.g., a telephone) at the destination responds to initiation of the communication path by providing an alert notification (e.g., starts ringing). As discussed below in connection with FIGS. 4 and 5, the example FS 180 uses the call setup time durations to determine when to initiate the communication session and/or path to each parallel ring destination such that each of the destinations are perceived to be alerted (e.g., rung) at substantially the same time.

To allow a person (e.g., a subscriber, a network operator, a technician) to configure the call setup time durations for parallel ring destinations, the example IMS 140 of FIG. 1 includes any variety of configuration interface(s) 190. The example configuration interface 190 is a web-based interface that allows, for example, a subscriber to configure the subscriber's list of parallel ring destinations and the associated call setup time delays. For example, consider a subscriber who first configures two parallel ring destinations for the subscriber's telephone number without configuring any call setup delays. The subscriber next tests the parallel ring configuration by calling the subscriber's telephone number and notes and/or records any time difference between when the two phones associated with the two parallel ring destinations ring. The subscriber then reconfigures the call setup delay for the destination that rung last with the time difference. If the subscriber then retests the parallel ringing configuration, the example FS 180 of FIG. 1 will delay the communication session and/or path initiation to the destination that initial rung first such that the subscriber now perceives the two phones associated with the two parallel ring destinations as ringing at substantially the same time.

Alternatively, the example configuration interface 190 includes one or more check boxes and/or pull-down menu selections that allow a subscriber to provide and/or specify information describing the type of each of the parallel ring destinations (e.g., cellular, PSTN, cellular operator, geographic location, etc.). Then using the additional information regarding the type of called destination, the example IMS 140 automatically estimates the call setup delay associated with each destination. For example, a technician may have determined and/or estimated that the call setup time from the IMS 140 to a cellular destination associated with service provider X is about 3 seconds. That estimate can then be used by the IMS 140 to populate the call setup duration (i.e., delay) for those types of parallel ring destination.

To allow the example IMS 140 of FIG. 1 to automatically determine and/or estimate call setup times, the IMS 140 includes any variety of delay determiner 195. The example delay determiner 195 of FIG. 1, using any variety of techniques, methods and/or communication paths, determines and/or estimates call setup times. For example, the delay determiner 195 could periodically or a periodically initiate a test call setup to various types of destinations to determine and/or estimate call setup times. The information estimated and/or determined by the example delay determiner 195 could be used together with destination type information, as described above, to determine a call setup delay associated with a particular parallel ring destination.

It will be readily appreciated by persons of ordinary skill in the art that the example MGC 160, the example S-CSC 165, the example I-CSC 170, the example HSS 175 and the example FS 180 illustrated in FIG. 1 are logical entities in IMS networks. They may be implemented, for example, as machine accessible instructions executed by one or more computing devices and/or computing platforms. Further, while an example IMS 140 has been illustrated in FIG. 1, the example logical entities of the IMS 140 may be combined, re-arranged, eliminated and/or implemented in any of a variety of ways. For example, the parallel ring database 185 may be implemented by and/or included within the example HSS 175. Further still, the example MGC 160, the example S-CSC 165, the example I-CSC 170, the example HSS 175, the example FS 180, the example parallel ring database 185, the example interface 190, the example delay determiner 195 and/or, more generally, the example IMS 140 may be implemented by hardware, software, firmware and/or any combination of hardware, software and/or firmware. Moreover, an IMS network may include additional logical entities and/or may include more than one of any of the illustrated logical entities.

FIG. 2 is a schematic diagram of an example manner of implementing the example FS 180 of FIG. 1. To receive an incoming call notification and to initiate outgoing call setups to parallel ring destinations (i.e., perform parallel ring operations), the example FS 180 of FIG. 6 includes any variety of programmable processor 205. The example processor 205 of FIG. 2 executes coded instructions 210 present in a main memory (e.g., within a random access memory (RAM) 215 as illustrated and/or within a read only memory (ROM) 220) and, thus, accessible to the processor 205. The example processor 205 may be any type of processing unit, such as, for example, a general purpose microprocessor from the AMD®, Sun® and/or Intel® families of microprocessors. The example processor 205 may execute, among other things, the example machine accessible instructions illustrated in FIG. 5 to perform parallel ring operations such as, for example, the example parallel ring operation illustrated in FIG. 4.

The example processor 205 of FIG. 2 is in communication with the example main memory (including the ROM 220 and the RAM 215) via a bus 225. The example RAM 215 of FIG. 2 may be implemented by dynamic random access memory (DRAM), Synchronous DRAM (SDRAM), and/or any other type of RAM device, and the example ROM 220 of FIG. 2 may be implemented by flash memory and/or any other desired type of memory device. Access to the example memories 215 and 220 is typically controlled by a memory controller (not shown) in a conventional manner.

To receive input and/or provide outputs signals, the example FS 180 of FIG. 2 also includes a conventional interface circuit 230. The interface circuit 230 may be implemented by any type of well-known interface standard, such as an external memory interface, serial port, general purpose input/output, etc. One or more input devices 235 and one or more output devices 240 are connected to the interface circuit 230.

To allow the example FS 180 of FIG. 2 to interact with the other logical entities of FIG. 1 (e.g., the example S-CSC 165 and/or the MGC 160), the example FS 180 of FIG. 2 includes any variety of network interface 245 such as, for example, a wired LAN interface in accordance with, for instance, the Institute of Electronics and Electrical Engineers (IEEE) 802.3z standard. The example processor 205 of FIG. 2 uses the example network interface 245 to, for example, receive incoming call invitations and to initiate outgoing parallel ring call setups.

Additionally or alternatively, the other logical entities of FIG. 1 may be implemented as additional machine accessible instructions contained in, for instance, the coded instructions 210 and carried out sequentially and/or in parallel by, for example, separate processing threads of the example processor 205.

Although an example FS 180 has been illustrated in FIG. 2, feature servers may be implemented using any of a variety of other and/or additional devices, components, circuits, modules, etc. For example, a feature server may be implemented with two or more processors. Further, the devices, components, circuits, modules, elements, etc. illustrated in FIG. 2 may be combined, re-arranged, eliminated and/or implemented in any of a variety of ways.

FIG. 3A illustrates an example data structure to store parallel ring configuration information for a particular subscriber. To represent the plurality of parallel ring destinations configured and/or enabled for a particular subscriber, the example data structure of FIG. 3A includes a plurality of entries 305 each having a destination field 310 to specify a destination and an associated delay field 315 to specify a call setup time duration for the associated destination. Example destinations 310 include any variety of telephone numbers, IP addresses, email addresses, etc.

FIG. 3B illustrates another example data structure to store parallel ring configuration information for a particular subscriber. To represent the plurality of parallel ring destinations configured and/or enabled for a particular subscriber, the example data structure of FIG. 3B includes a plurality of entries 335, each having a destination field 340 to specify a destination and an associated type field 345 to specify and/or describe the type of associated destination. Example destinations 340 include any variety of telephone numbers, IP addresses, email addresses, etc. Example type information 345 includes any variety and/or pieces of destination type identification information such as, for example, cellular, PSTN, cellular operator, geographic location, etc. from which the example FS 180 and/or the example delay determiner 195 of FIG. 1 can estimate and/or determine a call setup delay for the associated destination.

FIG. 4 illustrates an example parallel ring operation that is performed by the example IMS 140 of FIG. 1 across both the example VoIP network 140 and the example cellular network 135. The example operation of FIG. 4 begins with an incoming call for a subscriber of the example IMS 140 being received at the example MGC 160 as indicated with reference numeral 404. In response to the incoming call, the MGC 160 sends a SIP INVITE message 408 to the example I-CSC 170.

The I-CSC 170 responds with a SIP 100 TRYING message 412 to the MGC 160 effectively acknowledging SIP INVITE message 408 and indicating that it is trying to locate and route the INVITE to the subscriber's S-CSC. The I-CSC 170 then sends a location information request (LIR) 416 to the example HSS 175 and receives back a location information answer (LIA) 416 specifying the subscriber's S-CSC (e.g., the example S-CSC 165). Having received the LIA 416, the I-CSC 170 routes the SIP INVITE message 408 or a portion thereof to the S-CSC 165 as indicated with reference numeral 420.

Upon receipt of the forwarded INVITE message 420, and using subscriber information downloaded to the S-CSC 165 during registration of the subscriber, the example S-CSC 165 determines whether the subscriber has parallel ringing configured and/or enabled. Assuming parallel ringing is enabled, the S-CSC 165 routes the INVITE message 420 to a FS that implements parallel ringing capability (e.g., the FS 180) as indicated with reference numeral 424. If parallel ringing is not enabled and/or configured, the S-CSC 165 may, for example, route the INVITE message 420 to the called destination (not shown).

Based on subscriber information associated with the subscriber, the FS 180 determines whether the subscriber has parallel ringing configured and/or enabled. Assuming for purposes of discussion that parallel ringing is enabled, the FS 180 initiates parallel ringing based upon the subscriber's configured parallel ring information. If parallel ringing is not enabled and/or configured, the FS 180 may, for example, route the INVITE message 424 to the called destination (not shown). Example parallel ring configuration data structures were discussed above in connection with FIGS. 3A and 3B. In the example of FIG. 4, the FS 180 locates the subscriber's configured parallel ring destination having the longest call setup time (e.g., the cellular telephone 125) and initiates a call setup to the telephone number associated with the longest call setup time (e.g., the cellular telephone 125) by sending a SIP INVITE message 428 to the subscriber's S-CSC 165. The FS 180 then waits (i.e., delays) for a period of time 432 approximately equal in length to the difference in call setup time between the destination with the longest call setup time and the destination with the next longest call setup time.

In response to the INVITE message 428, the S-CSC 165 routes an INVITE message 432 to the MGC 160 to initiate a telephone call (i.e., a communication path and/or session) to the telephone number associated with the cellular telephone 125. The MGC 160 in turn initiates a call setup to the cellular network 135 associated with the telephone number of the cellular telephone 125 (i.e., the parallel ring destination with the longest call setup time) as indicated with reference numeral 440.

The cellular network 135 performs any variety of uni- and/or bi-directional operations to initiate the requested call setup to the cellular telephone 125 as indicated with reference numerals 444 and 448. That is, there will be some time between when the call setup is requested by the FS 180 and the time when the cellular telephone 125 starts ringing (block 452). At the start of the time period illustrated with block 452, the cellular telephone 125 starts ringing and/or otherwise attempting to alert a user of the cellular telephone 125. In the example of FIG. 4, the elapsed time between the call setup initiation 428 and the ringing 452 substantially corresponds to the call setup delay for the cellular telephone 125.

After the delay time period 432 has elapsed, and possibly in parallel with some of the call setup to the cellular telephone 125 (e.g., references numerals 444 and 448), the FS 180 sends an INVITE message 456 to the subscriber's S-CSC 165 to initiate a call (i.e., a communication path and/or session) to the subscriber's VoIP phone 110 as indicated with reference numeral 456.

The S-CSC 165 routes the INVITE message 456 to the VoIP phone 110 as indicated with reference numeral 460. The VoIP Phone 110 responds with a 100 TRYING response message 464. Once the communication path is established, the VoIP phone 110 starts ringing (block 468). At the start of the time period illustrated with block 468, the VoIP phone 110 starts ringing and/or otherwise attempting to alert a user of the VoIP phone 110. Because of the time delay 432 between when the INVITE message 428 and the INVITE message 456 were sent by the FS 180, the start of the ringing 452 of the cellular telephone 125 and the start of the ringing 468 of the VoIP phone 110 may be perceived to start at substantially the same time as indicated by the line 472 even though, as illustrated in FIG. 4, they have different call setup time durations.

When the VoIP phone 110 starts ringing it sends a 180 RINGING message 476 to the S-CSC 165. Likewise, when the cellular telephone 125 starts ringing, it sends a ring indication 476 to the cellular network 135. The ring indication is forwarded and/or routed via the cellular network 135 to the MGC 160 as indicated with reference numerals 484 and 488. The MGC 160 then sends a corresponding 180 RINGING message 492 to the S-CSC 165. As illustrated in FIG. 4, even though the ringing of the VoIP phone 110 and the cellular telephone 125 occurred at perceptibly the same time, the RINGING messages 476 and 492 may be received at different time instants by the S-CSC 165.

While FIG. 4 illustrates a parallel ring operation that includes two destinations (i.e., the VoIP phone 110 and the cellular telephone 125) and was performed by the example IMS 140, persons of ordinary skill in the art will readily appreciate that the methods illustrated in FIG. 4 can be applied to parallel ring operations having more than two destinations across any number and/or variety of communication networks and/or may be performed by any variety of communication network. For example, the incoming call could have been received at a PSTN-based network that initiates parallel ringing to a PSTN-based destination, a VoIP destination and a cellular destination.

FIG. 5 illustrates a flowchart representative of example machine accessible instructions that may be executed to implement the example FS 180 of FIGS. 1 and/or 2 and/or the example parallel ring operation illustrated in FIG. 4. The example machine accessible instructions of FIG. 5 may be executed by a processor, a controller and/or any other suitable processing device. For example, the example machine accessible instructions of FIG. 5 may be embodied in coded instructions stored on a tangible medium such as a flash memory, or RAM associated with a processor (e.g., the coded instructions 210 associated with the example processor 205 of FIG. 2). Alternatively, some or all of the example flowchart of FIG. 5 may be implemented using an application specific integrated circuit (ASIC), a programmable logic device (PLD), a field programmable logic device (FPLD), discrete logic, hardware, firmware, etc. Also, some or all of the example flowchart of FIG. 5 may be implemented manually or as combinations of any of the foregoing techniques, for example, a combination of firmware, software and/or hardware. Further, although the example machine accessible instructions of FIG. 5 are described with reference to the flowchart of FIG. 5, persons of ordinary skill in the art will readily appreciate that many other methods of implementing the example FS 180 and/or the example parallel ring operation of FIG. 4 may be employed. For example, the order of execution of the blocks may be changed, and/or some of the blocks described may be changed, eliminated, sub-divided and/or combined. Additionally, persons of ordinary skill in the art will appreciate that the example machine accessible instructions of FIG. 5 be carried out sequentially and/or carried out in parallel by, for example, separate processing threads, processors, devices, circuits, etc.

The example machine accessible instructions of FIG. 5 begin with a feature server (e.g., the example FS 180) waiting to receive a SIP INVITE message (block 505). When a SIP INVITE message (e.g., the INVITE message 424 of FIG. 4) is received (block 505), the FS 180 determines if parallel ringing is configured and/or enabled for the subscriber associated with the INVITE message (block 510). If parallel ringing is not configured and/or enabled (block 510), the FS 180 routes the INVITE message to the destination VoIP device (block 515).

If parallel ringing is configured and/or enabled (block 510), the FS 180 determines the subscriber's parallel ring destination configured with the longest call setup time (i.e., delay) (block 520) and sends a SIP INVITE message (e.g., the INVITE message 428 of FIG. 4) to the determined destination (block 525). The FS 180 then determines the subscriber's parallel ring destination with the next longest call setup time (block 530), computes the difference between their call setup delays (block 535) and waits for an amount of time that is substantially equal to the difference to elapse (block 540). After the time difference has elapsed, the FS 180 sends a SIP INVITE message (e.g., the INVITE message 456 of FIG. 4) to the destination (block 545). If all of the subscriber's parallel ring destinations have been processed (block 550), control returns to block 505 to wait to receive another INVITE message. If not all of the subscriber's parallel ring destinations have been processed (block 550), control returns to block 530 to determine the destination with the next longest call setup delay.

Although this patent discusses various example implementations, persons of ordinary skill in the art will appreciate that these examples are not exhaustive and that many other example implementations exist. For example, persons of ordinary skill in the art will recognize that the order, size, and proportions of the memory illustrated in the example systems may vary. Additionally, although this patent discloses example systems including, among other components, software or firmware executed on hardware, it will be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, persons of ordinary skill in the art will readily appreciate that the above described examples are not the only way to implement such systems.

At least some of the above described example methods and/or apparatus are implemented by one or more software and/or firmware programs running on a computer processor. However, dedicated hardware implementations including, but not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of the invention are not limited to such devices, standards and/or protocols. For instance, SIP, IETF RFC 3161, IETF RFC 3262, IETF RFC 3263, IETF RFC 3264, IETF RFC 3265, IETF RFC 3266, ITU-T H.323, VoIP gateways, HSSs, I-CSCs, S-CSCs, MGCs, etc. represent examples of the current state of the art. Such standards and/or devices are periodically superseded by improved, faster or more efficient standards and/or devices having the same general purpose. Accordingly, replacement devices, standards and/or protocols having the same general functions are equivalents which are intended to be included within the scope of the accompanying claims.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A voice over Internet protocol (VoIP) apparatus comprising:
a database identifying a parallel ring destination associated with a VoIP destination; and
a VoIP feature server to respond to an incoming call to the VoIP destination by initiating a first call to the VoIP destination at a first time and initiating a second call to the parallel ring destination at a second time, wherein the first and the second times are based on a difference between a first call setup time duration associated with the VoIP destination and a second call setup time duration associated with the parallel ring destination.

2. A VoIP apparatus as defined in claim 1, wherein a first alert provided by a first device at the VoIP destination and a second alert provided by a second device at the parallel ring destination are perceived to provide an alert at substantially the same time.

3. A VoIP apparatus as defined in claim 1, wherein the parallel ring destination is associated with at least one of a cellular telephone number, a wireless telephone number, a public switched telephone network (PSTN) telephone number, a private enterprise telephone number, or a VoIP telephone number.

4. A VoIP apparatus as defined in claim 1, wherein the database is to store a data structure associated with the VoIP destination having:
a first record to associate the first call setup time duration with the VoIP destination; and
a second record to associate the second call setup time duration with the parallel ring destination.

5. A VoIP apparatus as defined in claim 1, further comprising a media gateway controller to initiate the second call to the parallel ring destination.

6. A VoIP apparatus as defined in claim 1, further comprising a configuration interface to allow a person to configure at least one of the first or the second call setup time durations.

7. A VoIP apparatus as defined in claim 1, further comprising a configuration interface to allow a person to specify a destination type for at least one of the VoIP destination or the parallel ring destination.

8. A VoIP apparatus as defined in claim 7, further comprising a delay determiner to determine at least one of the first or the second call setup time durations based on the destination type specified for the at least one of the VoIP destination or the parallel ring destination.

9. A VoIP apparatus as defined in claim 1, further comprising a delay determiner to determine the first and the second call setup time durations.

10. A VoIP apparatus as defined in claim 1, wherein the VoIP feature server is associated with an Internet protocol (IP) multimedia system (IMS).

11. A VoIP apparatus as defined in claim 1, wherein the VoIP destination is associated with a first communication network and the parallel ring destination is associated with a second communication network different than the first communication network.

12. A VoIP apparatus as defined in claim 11, further comprising a media gateway controller to communicatively couple the first communication network and the second communication network.

13. An apparatus comprising:
a memory to store delay information associated with a parallel ring tree; and
a communication device to initiate calls to destinations identified in the parallel ring tree at time instants selected based at least in part on the stored delay information.

14. An apparatus as defined in claim 13, wherein the communication device is a voice over Internet protocol (VoIP) feature server.

15. An apparatus as defined in claim 13, further comprising a configuration interface to allow at least one of a service provider, a customer service representative, a network operator or a subscriber to specify at least one of the parallel ring tree or the delay information associated with the parallel ring tree.

16. An apparatus as defined in claim 13, wherein the parallel ring tree is associated with a destination associated with at least one of a voice over Internet protocol (VoIP) communication network, a public switched telephone network (PSTN) based communication network, a wireless communication network, or a private enterprise communication network.

17. An apparatus as defined in claim 13, wherein the parallel ring tree defines a plurality of destinations, and each of the plurality of destinations is associated with at least one of a voice over Internet protocol (VoIP) telephone number, a public switched telephone network (PSTN) telephone number, a wireless telephone number, or a private enterprise telephone number.

18. A method comprising:
receiving an incoming call placed to a voice over Internet protocol (VoIP) destination;
initiating a first communication path to the VoIP destination at a first time; and
initiating a second communication path to a second destination at a second time, wherein an elapsed time difference between initiating the first time and the second time depends upon delays associated with the VoIP destination and the second destination.

19. A method as defined in claim 18, further comprising:
determining whether the delay associated with the second destination is longer that the delay associated with the VoIP destination; and
if the delay associated with the second destination is longer, initiating the second communication path to the second destination before initiating the first communication path to the VoIP destination, the elapsed time difference being substantially the difference between the delays.

20. A method as defined in claim 18, wherein the second destination is associated with at least one of a cellular telephone number, a wireless telephone number, a public switched telephone network (PSTN) telephone number, a private enterprise telephone number, or a VoIP telephone number.

21. A method as defined in claim 18, further comprising storing a data structure associated with the VoIP destination in a database, the data structure having:
a first record to store a telephone number associated with the VoIP destination and the delay associated with the VoIP destination; and
a second record to store a telephone number associated with the second destination and the delay associated with the second destination.

22. A method as defined in claim 18, further comprising determining at least one of the delay associated with the VoIP destination or the delay associated with the second destination based upon at least one of a known network characteristic, an experimentally determined network characteristic, or information specifying at least one of the VoIP destination or the second destination.

23. A method as defined in claim 18, further comprising determining the elapsed time difference so that a first device associated with the VoIP destination and a second device associated with the second destination provide an alert at substantially the same time.

24. An article of manufacture storing machine accessible instructions which, when executed, cause a machine to:
receive an incoming call placed to a voice over Internet protocol (VoIP) destination;
initiate a first communication path to the VoIP destination at a first time; and
initiate a second communication path to a second destination at a second time, wherein an elapsed time difference between initiating the first time and the second time depends upon delays associated with the VoIP destination and the second destination.

25. An article of manufacture as defined in claim 24, wherein the machine accessible instructions, when executed, cause the machine to:
determine whether the delay associated with the second destination is longer that the delay associated with the VoIP destination; and
if the delay associated with the second destination is longer, initiating the second communication path to the second destination before initiating the first communication path to the VoIP destination, the elapsed time difference being substantially the difference between the delays.

26. An article of manufacture as defined in claim 24, wherein the second destination is associated with at least one of a cellular telephone number, a wireless telephone number, a public switched telephone network (PSTN) telephone number, a private enterprise telephone number, or a VoIP telephone number.

27. An article of manufacture as defined in claim 24, wherein the machine accessible instructions, when executed, cause the machine to store a data structure associated with the VoIP destination in a database, the data structure having:
a first record to store a telephone number associated with the VoIP destination and the delay associated with the VoIP destination; and
a second record to store a telephone number associated with the second destination and the delay associated with the second destination.

28. An article of manufacture as defined in claim 24, wherein the machine accessible instructions, when executed, cause the machine to determine at least one of the delay associated with the VoIP destination or the delay associated with the second destination based upon at least one of a known network characteristic, an experimentally determined network characteristic, or information specifying at least one of the VoIP destination or the second destination.

29. An article of manufacture as defined in claim 24, wherein the machine accessible instructions, when executed, cause the machine to determine the elapsed time difference so that a first device associated with the VoIP destination and a second device associated with the second destination provide an alert at substantially the same time.
